(19) United States
(12) Patent Application Publication
(10) Pub. No.: US 2026/0035599 A1
(43) Pub. Date: Feb. 5, 2026

(54) INORGANIC ADHESIVE AND METHODS THEREOF

(71) Applicant: 3M INNOVATIVE PROPERTIES COMPANY, St. Paul, MN (US)

(72) Inventors: Shoji Takeuchi, Kanagawa (JP); Hiroki Arazoe, Tokyo (JP)

(21) Appl. No.: 18/997,392

(22) PCT Filed: Jul. 26, 2023
(86) PCT No.: PCT/IB2023/057553

§ 371 Date: Jan. 21, 2025

Related U.S. Application Data
(60) Provisional application No. 63/392,318, filed on Jul. 26, 2022.

(51) Int. Cl. C09J 11/04; C09J 133/02

(52) U.S. Cl. CPC C09J 11/04; C09J 133/02; C09J 2301/204

(57) ABSTRACT

An adhesive composition is provided, along with related assemblies and methods. The adhesive composition comprises a mixture of an alkali metal silicate; a polycarboxy late; and a catechol. Use of a carboxylated polymer in combination with the catechol wetting agent can increase viscosity and prevent adhesive permeation when coated onto a fibrous surface while also reducing surface tension of the solution to promote coating stability.

Provided is an inorganic adhesive composition. The provided inorganic adhesive composition is useful in bonding pollution control device assemblies.

### BACKGROUND

Since the mid-1970s, catalysts have been used to decrease the emission of toxic pollutants, such as carbon monoxide and hydrocarbons, from motor exhaust gases. These catalysts promote the oxidation of these compounds into carbon dioxide and water and are contained within pollution control devices known as catalytic converters. Advanced catalysts are capable of reducing nitrogen oxide emission to nitrogen gas, and these are found in three-way converters that can address all of these pollutants. Catalytic converters are incorporated into the exhaust system of automobiles and other vehicles. These have been effectively mandated for gas-powered vehicles in jurisdictions where exhaust emissions are regulated.

Other pollution control devices can include catalytic monoliths, ceramic filters for a diesel particular filter (DPF), and ceramic filters for a gasoline particulate filter (GPF). These devices require a structure to secure the device within a metal housing, which is in turn connected to an exhaust system. The holding performance of the mounting assembly is generally dependent on a friction fit or in some cases on an adhesive. Securement of the converter to the automotive exhaust system is generally required over an extremely wide range of temperatures.

### SUMMARY

It can be advantageous to use an inorganic adhesive coating applied to a mounting mat interposed between a pollution control device and its metal housing. Alkali metal silicates such as sodium silicate, potassium silicate, or lithium silicate can be used as inorganic bonding agents. These materials can be activated by heat even after they are substantially dried on a bonding surface. This property is especially convenient in certain applications as it allows the bond closure after assembly of the mat without concern for workability or set time. There are, however, technical challenges in using alkali metal silicates as inorganic bonding agents on fibrous bonding surfaces, such as mat mounts for catalytic converters.

The present inventors have found that Alkali metal silicates tend to be of low viscosity when applied from aqueous solution. As a result, these compositions will soak deeply into the fibrous mat after a coating operation, reducing the amount of adhesive present on the surface. The surface interaction between the solution and the inorganic fibers can also cause the solution to readily wick into the mat material. This has the undesirable effect of not only decreasing bond strength, but also reducing flexibility of the mat and degrading the compressibility of the mat mount.

The provided adhesive composition can simultaneously address all of these technical problems. The provided adhesive compositions include a carboxylated polymer that increases viscosity and prevents soaking into mat body when coating on surface when processed in aqueous solution. This adhesive solution also includes a catechol wetting agent to reduce surface tension of the solution and further improve coating stability. Further, by keeping flexibility and compressibility, the adhesive-coated mat assemblies can be easily wrapped around a ceramic monolith. After assembly, the mat mount can hold ceramic monolith before bonding by retaining some degree of compressibility. The ceramic monolith is brittle, so flexibility of the mat can avoid inadvertent damage to the monolith during operation of the vehicle.

In a first aspect, an adhesive composition is provided. The adhesive composition comprises a mixture of: an alkali metal silicate; a thickener comprising a polycarboxylate; and a wetting agent comprising a catechol.

In a second aspect, a mounting mat assembly is provided, comprising a fibrous layer and the adhesive composition disposed thereon.

In a third aspect, a bonded assembly is provided comprising: a pollution control device; and the mounting mat assembly, wherein the adhesive composition bonds the fibrous layer to the pollution control device.

### BRIEF DESCRIPTION OF THE DRAWINGS

FIG. 1 is a side cross-sectional view of a bonded assembly according to one exemplary embodiment.

FIGS. 2A to 2D are perspective views of mounting mat assemblies according to various exemplary embodiments.

FIGS. 3-7 are side cross-sectional views of partially-bonded mounting mat assemblies according to various exemplary embodiments.

FIG. 8 is a schematic showing an exemplary method of making a partially-bonded mounting mat assembly.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the present disclosure in any way.

Reference throughout this specification to “one embodiment,” “certain embodiments,” “one or more embodiments” or “an embodiment” means that a particular feature, structure, material, or characteristic described relating to the embodiment is included in at least one embodiment of the present disclosure. Thus, the appearances of the phrases such as “in one or more embodiments,” “in certain embodiments,” “in one embodiment” or “in an embodiment” in various places throughout this specification are not necessarily referring to the same embodiment of the present disclosure.

In describing preferred embodiments of the present disclosure, specific terminology is used for the sake of clarity. The present disclosure, however, is not intended to be limited to the specific terms so selected, and each term so selected includes all technical equivalents that operate similarly.

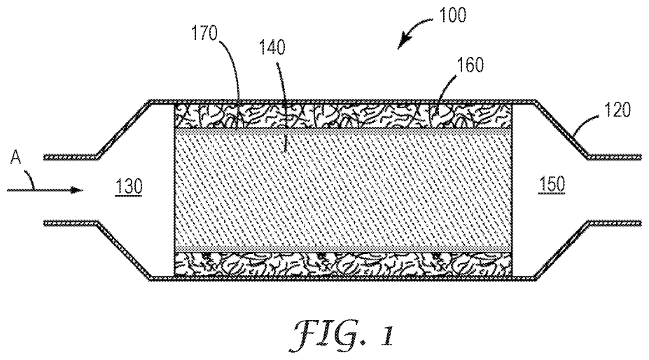

Referring to FIG. 1, an exemplary pollution control device according to the present disclosure is represented here as a bonded assembly 100. The bonded assembly 100 includes a housing 120, a pollution control element 140 mounted in the housing 120, and a mounting mat 160 disposed between the pollution control element 140 and the housing 120 thereby securing the element 140 at a desired position within the housing 120. The mounting mat 160 is not especially limited, but is typically made from a fibrous layer made from inorganic fibers.

Suitable inorganic fibers may comprise any of the fibers known and/or used in mounting mats for mounting pollution control devices. Useful inorganic fibers include for example, glass fibers, ceramic fibers, non-oxide inorganic fibers, such as graphite fibers or boron fibers, and mixtures thereof. Particularly useful are ceramic fibers that can be obtained from a so-called sol-gel process, which often are crystalline and are therefore also known as polycrystalline fibers. Various useful inorganic fibers may include, for example, those disclosed in U.S. Pat. No. 6,460,320 (Schierz et al.): 6,737,146 (Schierz et al.); and 7,033,412 (Kumar et al.).

A pollution control element 140 can be deemed within the housing 120 by wrapping the mat 160 around the pollution control element 140 and then placing the wrapped element in a desired location within the housing, a process sometimes referred to as “canning.” The mounting mat 160 is bonded to the pollution control element 140 by an adhesive layer 170. The housing 120, in this depiction, includes a cone-shaped inlet 130, through which exhaust gases flow into the assembly 100 (see arrow A) and a cone-shaped outlet 150 through which the exhaust gases flow out of the assembly 100.

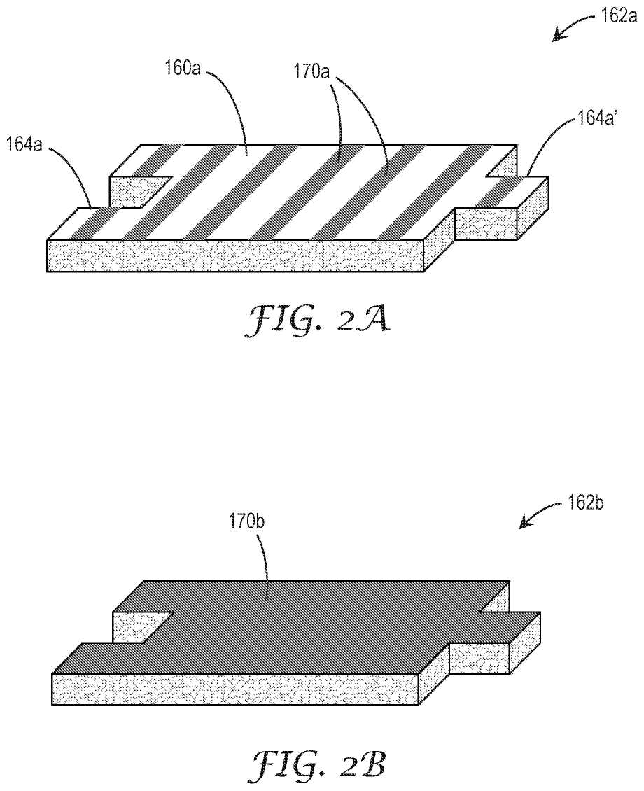

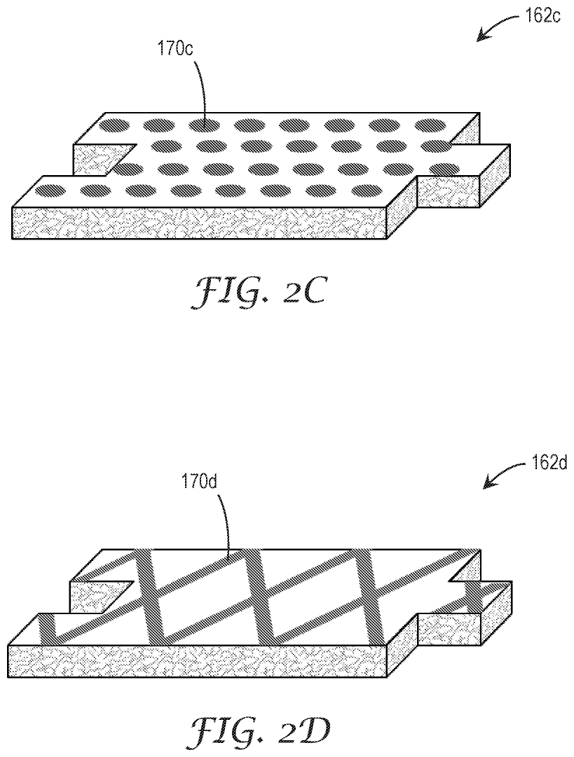

FIG. 2A shows the mat 160a and adhesive layer 170a in isolation within a partially-bonded assembly 162a. It can be convenient for the mat 160a to be pre-coated with the adhesive layer 170a. Such a pre-coated configuration can then be provided to an original equipment manufacturer (OEM) or aftermarket installer to perform the final assembly. The mat 160a includes mating registration features 164a, 164a′ that mutually interlock when the mat 160a is wrapped around a pollution control element in an encircling relation. The particular features 164a, 164a′ are exemplary only and many alternatives are also possible, such as the use of other interlocking shapes or even separate fasteners if so desired.

Optionally and as shown, the adhesive layer 170a is non-coextensive with the mounting mat 160a. In FIG. 2A, the adhesive layer 170a is disposed onto the mat in a discontinuous pattern, and more particularly in this instance, a striped pattern. The stripes may or may not be parallel to each other. If non-parallel, at least some of the stripes may intersect one another. In some embodiments, the adhesive layer 170a is represented by an array of replicated or randomized islands. Being made from inorganic materials, the adhesive layer 170a can be relatively stiff-depending on its thickness, it can be preferable to have an axial orientation (as opposed to circumferential orientation) of the stripes to facilitate wrapping of the mat 160a around a cylindrical object, such as the pollution control element 140 (FIG. 1). With the mounting mat 160a represented in a planar configuration, the adhesive layer 170a can be applied onto the mounting mat 160a according to any suitable two-dimensional pattern.

FIGS. 2B, 2C, and 2D show other possible two-dimensional patterns for the adhesive layer. FIG. 2B, for example, shows a partially-bonded assembly 162b with an adhesive layer 170b that is continuous and coextensive with the major surface of the assembly 162b overall. FIG. 2C shows a partially-bonded assembly 162c where an adhesive layer 170c is discontinuous and is comprised of a plurality of circular islands. FIG. 2D shows a partially-bonded assembly 162d having an adhesive layer 170d comprised of parallel and non-parallel stripes, in which the stripes intersect one another.

The composition used in the adhesive layer 170 can be prepared from a mixture of an alkali metal silicate, a polycarboxylate, and a catechol. At ambient temperatures (e.g., around 21° C.), the adhesive layer 170 is solid in its final form. Yet, the adhesive layer 170 is generally prepared from an aqueous solution where the alkali metal silicate, polycarboxylate, and catechol are homogeneously dispersed in water. The aqueous solution can be then coated onto a pollution control element or mounting mat and the water removed to afford a solid adhesive layer. The aqueous solution is stable at ambient temperatures, allowing the adhesive to be provided to an end user in liquid form if so desired. These primary components need not be exclusive, and other additives may also be included. Such additives can include, for example, a dye or pigment to help visually discern where the adhesive solution has been coated.

Other useful additives can include fillers for controlled soaking and viscosity control, as well as hardening agents for increasing thermal durability. Example of filler might be fine particles of inorganic materials such as silica, alumina, mullite, zirconia, magnesia, and clays. Example of hardening agents include zinc oxide, zinc hydroxide, magnesium oxide, magnesium hydroxide, aluminum oxide, aluminum hydroxide, phosphate, and borate.

The alkali metal silicate can include sodium silicate, potassium silicate, lithium silicate, or a combination thereof. In some embodiments, the alkali silicate is sodium silicate. Sodium silicate, also known as water glass, is an inorganic compound that contains an anionic polymeric chain composed of tetrahedral SiO₄ units. The drying and curing process of a sodium silicate aqueous solution involves a condensation polymerization that combines two silanol groups generated by hydrolysis and releases one water molecule. Sodium silicate has a wide spectrum of applications, including cement for making paper board, water treatment, passive fire protection and automotive repairing. Most notably, it has high temperature performance and is both flame resistant and intumescent.

The alkali metal silicate is generally the majority component of the adhesive and can be present in any suitable amount. The alkali metal silicate can be from 40 weight percent to 99 weight percent, from 70 weight percent to 97 weight percent, from 85 weight percent to 95 weight percent, or in some embodiments, less than, equal to, or greater than 40 weight percent, 45, 50, 55, 60, 65, 70, 75, 80, 85, 90, 95, 97, 98, or 99 weight percent of the overall solids weight of the adhesive composition.

The polycarboxylate, or carboxylate polymer, can function as a thickener for the adhesive composition when it is in its aqueous form. Generally, these are linear polymers that are water-soluble and characterized by their polar carboxylate (—COO⁻) groups. Simple polycarboxylates can be prepared as homopolymers of acrylic acid, copolymers of acrylic acid and maleic acid, maleic terpolymers, or any mixtures thereof. As one example, polyacrylic acid has the following chemical structure:

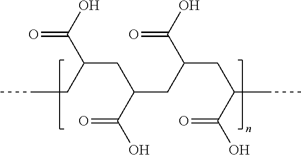

where n can be any positive integer.

Polymaleic acid, as another example, has the following chemical structure:

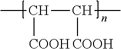

where n can be any positive integer.

As thickeners in alkali solutions, useful polycarboxylates include sodium polycarboxylate, potassium polycarboxylate, sodium carboxymethyl cellulose, potassium carboxymethyl cellulose, and combinations thereof.

Useful polycarboxylic acids (or salts thereof) include those having a molecular weight of from 3000 g/mol to 1×10⁷ g/mol, 10,000 g/mol to 8×10⁶ g/mol, 1×10⁵ g/mol to 6×10⁶ g/mol, or in some embodiments, less than, equal to, or greater than 3000 g/mol: 4000; 5000; 7000:10,000; 50,000: 1×10⁵: 5×10⁵, 1×10⁶, 3×10⁶, 5×10⁶, 7×10⁶, or 1×10⁷ g/mol. One source of commercially available polyacrylic acid homopolymers useful in the present disclosure includes the ACUSOL 445 series from The Dow Chemical Company, Wilmington, DE, USA. Other polyacrylic acid homopolymers (and salts thereof) commercially available are ACUSOL 929 (10,000 MW) and ACUMER 1510 (60,000 MW) both also available from Dow Chemical. Yet another commercially available polyacrylic acid is AQUATREAT AR-6 (100,000 MW) from AkzoNobel Strawinskylaan 2555 1077 ZZ Amsterdam Postbus 75730 1070 AS Amsterdam. Yet another commercially available polyacrylic acid is AQUALIC IH (3-5×10⁶ MW) from Nippon Shokubai, Osaka, Japan.

As a thickener, the polycarboxylate can increase viscosity and reduce the degree to which the adhesive soaks into the mat. Various conventional organic polymers can be used for this purpose, including polyvinyl acetate, polyethylene oxide, polyamine, and others. When being combined with concentrated solutions of sodium silicate, however, these polymers tend to be insoluble. Advantageously, it was discovered that certain carboxylated polymers above such as sodium carboxylate or sodium carboxymethyl cellulose can remain fully soluble in alkali solutions. The pH of such alkali solutions with sodium silicate can be from 9 to 13, from 10 to 12, or in some embodiments, less than, equal to, or greater than 9, 10, 11, 12, or 13.

Carboxymethyl cellulose can be available in various molecular weights. Low molecular weight carboxymethyl cellulose has a Mw of about 90,000 g/mol and a 2% solution thereof will have a viscosity of about 1.1 cP at 25° C. Medium weight carboxymethyl cellulose has a Mw of about 250,000 g/mol. High molecular weight carboxymethyl cellulose has a Mw of about 700,000 g/mol and a 2% solution will have a viscosity of about 12 cP at 25° C.

The polycarboxylate can be present in any amount appropriate to achieve the desired texture or viscosity when the adhesive is in aqueous solution. The polycarboxylate can be from 1 weight percent to 30 weight percent, from 1.5 weight percent to 20 weight percent, from 2 weight percent to 10 weight percent, or in some embodiments, less than, equal to, or greater than 1 weight percent, 1.5, 2, 2.5, 3, 3.5, 4, 4.5, 5, 6, 7, 8, 9, 10, 11, 12, 15, 17, 20, 25, or 30 weight percent of the overall solids weight of the adhesive composition.

Catechols are benzenediol compounds that include a benzene core carrying two hydroxy substituents in an ortho arrangement relative to each other and are conjugate acids of catecholates. The basic chemical structure of a catechol is as follows:

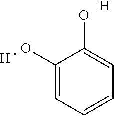

Alkyl groups or other chemical groups can be covalently bonded to the aryl group in the structure above to obtain more complex catechols.

In the provided adhesive compositions, catechols such as 4-tert-butylpyrocatechol were found to be surprisingly effective wetting agents. Conventional surfactant wetting agents, such as polyoxyethylene alkyl ether, can also be used but it was discovered that these wetting agents can adversely impact adhesive strength of the inorganic adhesive after heat curing. Empirical data has shown catechol to perform well as a wetting agent, readily dissolve in alkali solutions, and substantially avoid reducing bond strength of the inorganic adhesive to ceramic monoliths, such as those made from cordierite.

The catechol component should be present in an amount that realizes the optimal wetting properties of the aqueous adhesive composition on the mounting mat, which in turn depends on surface characteristics of the mounting mat. For useful inorganic fibrous mounting mats, the polycarboxylate can be from 0.05 weight percent to 10 weight percent, from 0.1 weight percent to weight percent, from 0.15 weight percent to 2 weight percent, or in some embodiments, less than, equal to, or greater than 0.05 weight percent, 0.1, 0.15, 0.2, 0.25, 0.3, 0.35, 0.4, 0.45, 0.5, 0.6, 0.7, 0.8, 0.9, 1, 1.1, 1.2, 1.5, 1.7, 2, 3, 4, 5, 6, 7, 8, 9, or 10 weight percent of the overall solids weight of the adhesive composition.

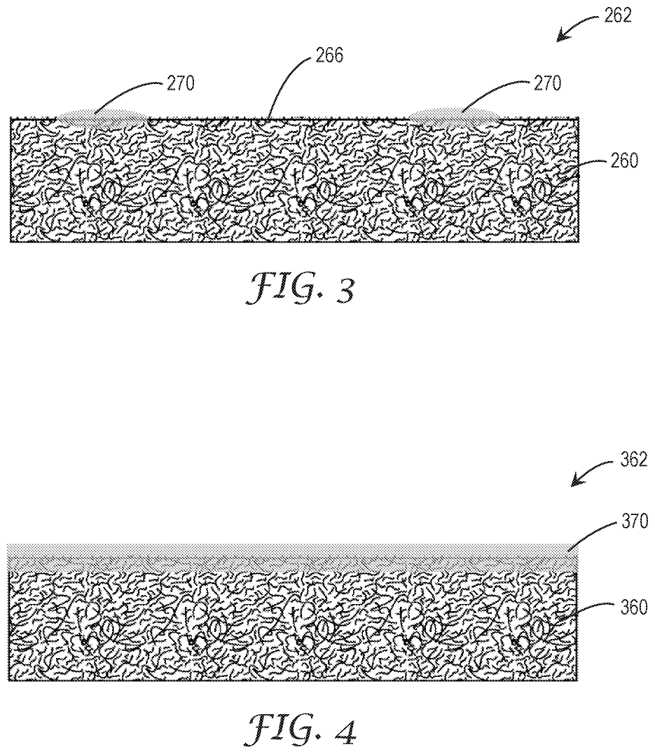

FIG. 3 depicts a partially-bonded assembly 262 that illustrates a useful property of the provided adhesive compositions when coated onto the mounting mat in aqueous form. As shown in this cross-sectional view, a mounting mat 260 is coated along its top major surface 266 with a discontinuous adhesive layer 270, which is exposed over the top major surface 266 of the mounting mat 260. The mounting mat thickness can be application-specific and is not particularly restricted but typically has a thickness of from 6 to 15 millimeters. The adhesive layer 270 can be coated according to any suitable pattern, as described previously with respect to the partially-bonded assembly 162.

Referring again to FIG. 3, the adhesive layer 270 has an exposed surface that is convex and covers certain surface regions of the mounting mat 260. At the same time, the adhesive layer 270 also permeates into the mounting mat 260 to some extent. The overall thickness of the adhesive layer 270, including the portions residing both above and below the plane of the top major surface 266, can be from 0.01 millimeters to 4.5 millimeters, from 0.3 millimeters to 4.2 millimeters, from 0.35 millimeters to 2.0 millimeters, or some embodiments less than, equal to, or greater than 0.01 micrometers, 0.05, 0.1, 0.2, 0.3, 0.35, 0.4, 0.5, 0.7, 1, 1.2, 1.5, 1.7, 2, 2.5, 3, 3.5, 4., 4.2, or 4.5 millimeters. The extent of permeation, or portion of the overall thickness absorbed into the mounting mat, can be from 0 percent to 28 percent, from 0 percent to 25 percent, from 0 percent to 20 percent, or in some embodiments less than, equal to, or greater than 0 percent, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 percent of the overall thickness of the adhesive layer 270.

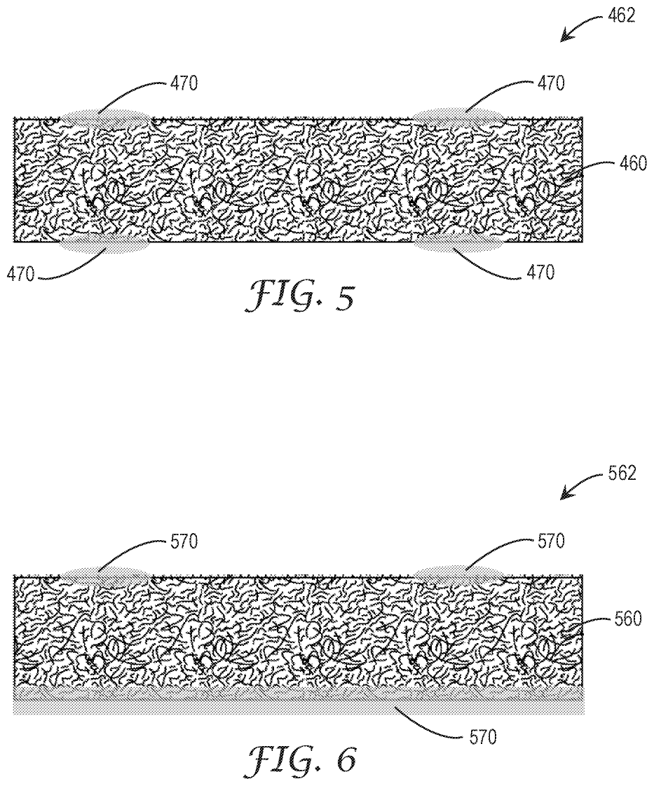

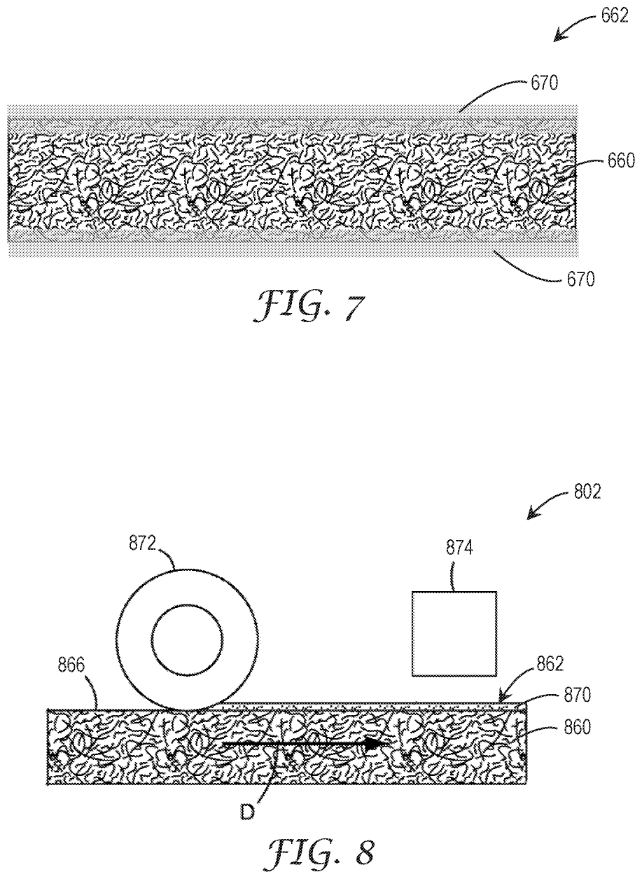

FIGS. 4-7 show alternative configurations of the adhesive layer in cross-sectional view. FIG. 4 shows an assembly 362 with an adhesive layer 370 that extends continuously across the mounting mat 360: FIG. 5 shows an assembly 462 where the adhesive layer 470 is discontinuously disposed on both major surfaces of the mounting mat 460; FIG. 6 shows an assembly 562 where the adhesive layer 570 is discontinuous on one major surface of a mounting mat 560 but continuous on its opposing major surface; and finally FIG. 7 shows an assembly 662 with a continuous adhesive layer 670 extending across both of its major surfaces. By having adhesive layers on both major surfaces, the mounting mat can be adhesively bonded to both the housing and pollution control element as arranged in FIG. 1. Other options and advantages of the aforementioned adhesive layer configurations have been visited already and shall not be repeated.

FIG. 8 illustrates an exemplary method 802 of making a partially-bonded assembly 862. In this method, a continuous web comprised of a mounting mat 860 is transported along a downstream direction D (as indicated) using a conventional conveyor belt system. The mounting mat 860 can be made according to any conventional technique (e.g., conventional wetlaid or drylaid processes). As the mounting mat 860 is conveyed downstream, a film, coating or layer of adhesive 870 can be deposited by roll coater 872 onto the exposed top major surface 866 of the mounting mat 860.

The top major surface 866 of the mounting mat 860 is then exposed to an energy source 874 that activates the adhesive 870 on the top major surface 866 of the mounting mat 860. Such activation of the bonding agent can occur, for example, by passing the web through heated air (e.g., in an oven, under a heat lamp, etc.), in contact with a heated surface, under an ultraviolet light source, or under an e-beam source, depending on what is needed to activate the bonding agent. The resulting partially-bonded mounting mat assembly can be formed (e.g., die or laser cut) into individual mounting mats or alternatively wound into a roll for subsequent converting into individually packaged mounting mats.

### Examples

Objects and advantages of this disclosure are further illustrated by the following non-limiting examples, but the particular materials and amounts thereof recited in these examples, as well as other conditions and details, should not be construed to unduly limit this disclosure. Where applicable, brand names and trademarked names are shown in all caps.

TABLE 1

| Designation | Description | Source |
|---|---|---|
| SILICATE | Potassium silicate, 30% solids | Fuji Chemical, Osaka, |
| | | Japan |
| ACRYLATE | Sodium polyacrylate, available under the | Nippon Shokubai, Osaka, |
| | trade designation AQUALIC IH | Japan |
| CMC | Carboxymethyl cellulose, available under the | Daicel Corp., Osaka, |
| | designation CMC 1390 | Japan |
| PEO | Polyethylene oxide, available under the | Meisei Chemical, Kyoto, |
| | designation ALKOX E240 | Japan |
| TBC | 4-tert-Butyl pyrocatechol, available under the | DIC Corporation, Tokyo, |
| | designation DIC-TBC | Japan |
| POAE | Polyoxyethylene alkyl ether, available under | Sanyo Chemical, Kyoto, |
| | the trade designation SANNONIC SS-90 | Japan |
| BLUE | Blue pigment, available under the designation | Orient Chemical Industries, |
| | MICROPIGMOR WMBE-71 | Osaka, Japan |

### Test Methods and Calculations

### Coating Preparation-Basis Weight

A 12 cm×16 cm size 1180 grams per square meter (gsm) 3M INTERAM Mat Mount 1450 HR (3M Company, St. Paul, MN, United States) was weighed. Coating solution samples were applied to the mat in lines with a syringe along the width. The lines were spaced 10 mm apart from each other and the samples were visually reviewed for consistency in their width, length, and thickness of the applied lines. Approximately, 16 lines were applied. The coated mat was then dried at 150° C. for five minutes. The coated mat was then weighed. Average coating weight per area was calculated by subtracting the uncoated mat weight from the coated mat weight and then dividing by coating area.

### Coating Stability

A coating solution sample was applied to a 12 cm×16 cm size 3M INTERAM Mat Mount 1450 HR. Coating solution samples were applied to the mat in lines with a syringe along the width. The lines were spaced 10 mm apart from each other and the samples were visually reviewed for consistency in their width, length, and thickness of the applied lines. Approximately, 16 lines were applied. Visual assessment was performed to determine if the coating solution repelled from the surface of mat. If the coating solution did not repel during application, then coating stability was noted as OK. If the coating solution repelled, then coating stability was noted as REPEL.

### Soaking Depth

A coating solution sample was applied to a 12 cm×16 cm size 3M INTERAM Mat Mount 1450 HR. Coating solution samples were applied to the mat in lines with a syringe along the width. The lines were spaced 10 mm apart from each other and the samples were visually reviewed for consistency in their width, length, and thickness of the applied lines. Approximately, 16 lines were applied. The coated mat was then dried at 150° C. for five minutes. The mat was cross-sectionally cut over the line of the applied coating solution. The mat was then compressed to about 7.2 mm thickness. The depth of coating in the mat was measured and then divided by mat thickness to calculate percentage soaking depth.

### Adhesion

A HONEYCERAM® cordierite plate was prepared by cutting the catalytic monolith (NGK Insulators, LTD, Aichi, Japan) along the cell. The surface of plate was polished to remove burr and prepared as an adherend. A coating solution sample was uniformly applied to a cut to 50 mm×50 mm size 3M INTERAM Mat Mount 1450 HR. The samples were visually reviewed for consistency in their width, length, and thickness of the applied coating The coated mat was placed on the cordierite plate, compressed to the mat thickness to 5 mm and heat treated at 900° C. for one hour. After heat treatment, the coated mat was peeled off the plate. The areas (length×width) of the coating sample that was visibly bonded to the plate surface (A₁) and what remained bonded to the mat surface (A₂) were measured. A bonding area ratio was calculated by dividing A₁ by the sum of A₁ and A₂ and multiplying by 100.

Examples 1-6(EX1-EX6) and Comparative Examples 1-5(CE1-CE5)

Quantities of materials in grams were mixed as represented in Table 2. The basis weight of the coating solution was also calculated and is recorded in Table 2. The solid components in all sample solutions except CE5 were observed to dissolve uniformly into the water to provide a homogeneous solution.

TABLE 2
Coating Solution Compositions (in grams)

| | | | | | | | | | Coating |
|---|---|---|---|---|---|---|---|---|---|
| | | | | | | | | | Weight |
| | SILICATE | ACRYLATE | CMC | PEO | TBC | POAE | BLUE | WATER | (gsm) |
| EX1 | 50 | 0.98 | | | 0.09 | | 0.03 | 10.5 | 111 |
| EX2 | 50 | 0.33 | | | 0.09 | | 0.03 | 10.5 | 105 |
| EX3 | 50 | 1.96 | | | 0.09 | | 0.03 | 10.5 | 118 |
| EX4 | 50 | 0.98 | | | 0.03 | | 0.03 | 10.5 | 120 |
| EX5 | 50 | 0.98 | | | 0.3 | | 0.03 | 10.5 | 119 |
| EX6 | 50 | | 0.98 | | 0.09 | | 0.03 | 10.5 | 106 |
| CE1 | 50 | 0.98 | | | | | 0.03 | 10.5 | 110 |
| CE2 | 50 | | | | 0.09 | | 0.03 | 10.5 | 123 |
| CE3 | 50 | | | | | | 0.03 | 10.5 | 148 |
| CE4 | 50 | 0.98 | | | | 0.09 | 0.03 | 10.5 | 125 |
| CE5 | 50 | | | 0.98 | 0.09 | | 0.03 | 10.5 | 126 |

Testing was conducted, and the results are represented in Table 3.

TABLE 3
Coating Solution Test Results

| | | | Bonding |
|---|---|---|---|
| | | Soak | Area |
| | Coating | Depth | Ratio |
| | Stability | (%) | (%) |
| EX1 | OK | 12 | 77 |
| EX2 | OK | 13 | 81 |
| EX3 | OK | 11 | 100 |
| EX4 | OK | 10 | 98 |
| EX5 | OK | 10 | 87 |
| EX6 | OK | 12 | 85 |
| CE1 | REPEL | 16 | 100 |
| CE2 | REPEL | 31 | 4 |
| CE3 | REPEL | 29 | 73 |
| CE4 | OK | 17 | 0 |
| CE5 | REPEL | 18 | 1 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive composition comprising a mixture of:
an alkali metal silicate;
a polycarboxylate; and
a catechol.

2. The adhesive composition of claim 1, wherein the alkali metal silicate comprises sodium silicate, potassium silicate, lithium silicate, or a combination thereof.

3. The adhesive composition of claim 1, wherein the polycarboxylate comprises sodium polycarboxylate, potassium polycarboxylate, sodium carboxymethyl cellulose, potassium carboxymethyl cellulose, or a combination thereof.

4. The adhesive composition of claim 1, wherein the catechol comprises 4-tert-butylpyrocatechol.

5. The adhesive composition of claim 1, wherein the alkali metal silicate is present in an amount of from 40 weight percent to 99 weight percent, relative to the overall solids weight of the adhesive composition.

6. The adhesive composition of claim 1, wherein the polycarboxylate is present in an amount of from 1 weight percent to 30 weight percent, relative to the overall solids weight of the adhesive composition.

7. The adhesive composition of claim 1, wherein the catechol is present in an amount of from 0.05 weight percent to 10 weight percent, relative to the overall solids weight of the adhesive composition.

8. The adhesive composition of claim 1, wherein the adhesive composition is a solid coating.

9. An adhesive composition of claim 1, further comprising water, wherein the alkali metal silicate, polycarboxylate; and catechol are homogeneously dispersed in the water.

10. A mounting mat assembly comprising a fibrous layer and the adhesive composition of claim 1 applied thereon.

11. The assembly of claim 10, wherein the adhesive composition is disposed on the fibrous layer in a discontinuous pattern.

12. The assembly of claim 10, wherein from 0 percent to 28 percent of the overall thickness of the adhesive composition is absorbed into the fibrous layer.

13. A bonded assembly comprising:
a pollution control device; and
the mounting mat assembly of claim 1, wherein the adhesive composition bonds
the fibrous layer to the pollution control device.

14. The bonded assembly of claim 13, wherein the pollution control device comprises a catalytic monolith, ceramic filter for a diesel particular filter (DPF), or ceramic filter for a gasoline particulate filter (GPF).

15. The bonded assembly of claim 13, further comprising a housing also bonded to the mounting mat by the adhesive.
